(19) United States
(12) Patent Application Publication
(10) Pub. No.: US 2004/0061499 A1
(43) Pub. Date: Apr. 1, 2004

(54) Magnetic resonance device

(75) Inventor: Stefan Stocker, Erlangen (DE)

Correspondence Address: SCHIFF HARDIN, LLP, PATENT DEPARTMENT, 6600 SEARS TOWER, CHICAGO, IL, 60606-6473, US

(73) Assignee: Siemens Aktiengesellschaft

(21) Appl. No.: 10/671,899

(22) Filed: Sep. 26, 2003

(30) Foreign Application Priority Data
Sep. 30, 2002 (DE) 10245942.8

(51) Int. Cl. G01V 3/00

(52) U.S. Cl. 324/318

(57) ABSTRACT

A magnetic resonance device includes a hollow with an internal surface, a gradient coil system having an outer surface being arranged in the hollow with an interval space being formed between the boundary surface of the hollow and an outer surface of the gradient coil and at least one form-flexible hollow body being arranged between the boundary surface and the outer surface and having an arrangement for adjusting the inner pressure so that the interval space can be sealed from the outside.

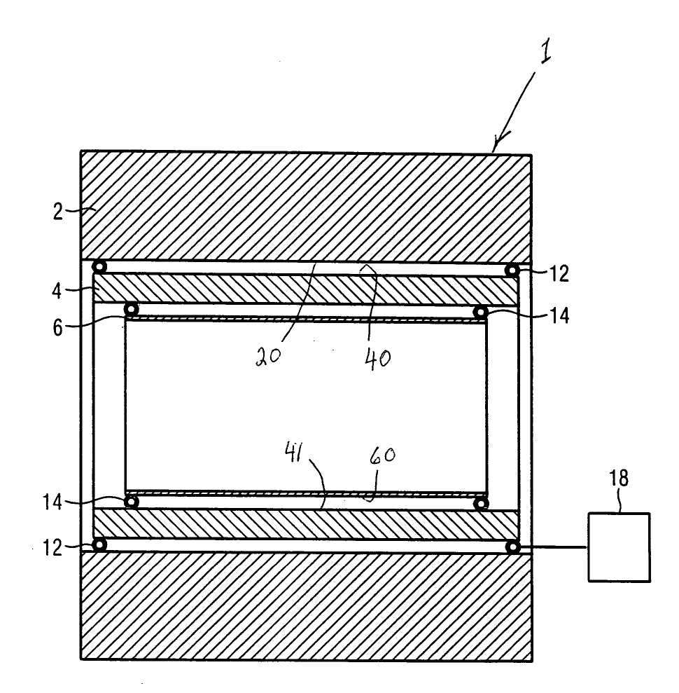

### BACKGROUND OF THE INVENTION

The present invention is directed to an improved magnetic resonance device.

The magnetic resonance technology is a known technology for, among other things, acquiring images of the inside of a body of an examination subject. In a magnetic resonance device, a static basic magnetic field, that is generated by a basic field magnet, interferes with quickly switched gradient fields that are generated by a gradient coil system. In addition, the magnetic resonance device comprises a high-frequency system that, to start the magnetic resonance signals, radiates the high-frequency signals into the examination subject and acquires the triggered magnetic resonance signals, which are used to create or generate the magnetic resonance images.

To generate gradient fields, corresponding currents are adjusted in gradient coils of the gradient coil system. The amplitudes of the necessary currents are thereby up to more than 100A. The current rise and fall rates are up to more than 100 kA/s. An existing basic field magnet affects these temporally varying currents in the gradient coils on the order of 1 T Lorentz forces, which leads to mechanical oscillations in the gradient coil system. These oscillations are reproduced over varying propagation paths on the surface of the magnetic resonance device. The mechanical oscillations are transformed or transduced in the magnetic resonance device into sound oscillations that subsequently lead to undesired noise.

U.S. Pat. No. 6,107,799, whose disclosure is incorporated herein by reference thereto and which claims priority from DE 197 22 481, discloses a magnetic resonance device in which the basic field magnet comprises a first surface and a gradient coil comprises a second surface. Both surfaces are arranged separate from one another and facing one another and a noise reduction device, to dampen the oscillations of the gradient coil system and/or to stiffen the gradient coil system, is arranged in contact with both surfaces. In an embodiment of the device, the noise reduction device comprises corresponding seals to form a closed, sealed space between the two surfaces, so that the space is filled with sand, foam, a fluid under pressure or other oscillation-dampening and/or stiffening material. In another embodiment, a basic field magnet comprises a cylindrical cavity having a hollow in which the gradient coil system is arranged in the form of a hollow cylinder and the noise reduction device is formed of wedges that are spread between the two cylindrical surfaces.

U.S. Pat. No. 4,639,672, whose disclosure is incorporated herein by reference thereto, discloses a magnetic resonance device in a gradient coil system in the form of a hollow cylinder having a hollow in which, to dampen undesired noise, a bushing is arranged that is connected tight with the gradient coil system via two elastic, inflatable rings arranged on the axial ends of the bushing. The bushing can thereby be used as a carrier for an antenna system of the magnetic resonance device.

### SUMMARY OF THE INVENTION

An object of the present invention is to provide an improved magnetic resonance device in which, among other things, a low emission of noise is achieved.

This object is inventively achieved by a magnetic resonance device comprising a basic field magnet system having a hollow, a gradient coil system being arranged in the hollow so that an intervening space is formed between a boundary surface of the hollow and a surface of the gradient coil system, and at least one form-flexible hollow body that is provided between the surfaces and whose internal pressure is adjustable, so that the intervening space can be sealed from the outside.

In that the hollow body conforms to the corresponding internal pressure on the surfaces and, thus, seals the intervening space from the outside, a release from the intervening space of air oscillations generated by the gradient coil system is prevented and, thus, the noise emission of the magnetic resonance device in operation is advantageously reduced.

In an advantageous embodiment, the hollow body is fashioned to fasten the gradient coil system in the hollow. In addition, a transmission of mechanical oscillations originating from the gradient coil system to the rest of the magnetic resonance device is effectively dampened with advantage due to elastic properties of the hollow body, which is associated, among other things, with a further reduction of the noise emission of the magnetic resonance device during operation.

Other advantages and features of the invention will be readily apparent from the following description, the claims and drawings.

### BRIEF DESCRIPTION OF THE DRAWINGS

The FIGURE is a schematic cross-sectional view through a magnetic resonance device according to the present invention.

### DESCRIPTION OF THE PREFERRED EMBODIMENTS

The magnetic resonance device is generally indicated at 1 in the FIGURE. To generate a homogeneous static basic magnetic field, the device 1 comprises a superconductive basic field magnet 2 that has a cylindrical hollow with an internal hollow surface 20 with two opposite openings which are in the form of circular openings. In this hollow, a substantially hollow-cylindrical cast-resin-sealed gradient coil system 4 is arranged to generate quickly switchable gradient fields. The gradient coil system 4 comprises a first transversal gradient coil, a second transversal gradient coil, a cooling device to cool the gradient coils, a longitudinal gradient coil, active and/or passive shim devices, a further cooling device, a shielding coil associated with the longitudinal gradient coil, and a further shielding coil associated with the second transversal gradient coil.

The gradient coil system 4 has an outer surface 40, which is preferably cylindrical, and the coil system 4 is inserted in the basic field magnet with the outer surface 40 being spaced from the cylindrical surface 20 and is held in this position by two annular tubes 12, which are arranged on the axial ends of the gradient coil system 4 between the surface 40 of the gradient coil system 4 and a boundary surface 20 of the hollow of the basic field magnet 2. The tubes 12 are fashioned from a flexible material, for example rubber, and their internal pressure is adjustable, preferably increasable, via a pressure medium, which is preferably air, that can be introduced into the tubes 12, so that the tubes 12 enable an intervening space between the surface 40 of the gradient coil system 4 and the boundary surface 20 of the hollow to be terminated or sealed gas-tight. The tubes 12 are connected with a pressure control unit 18 for adjustment of the internal pressure and which unit 18 acts as means for adjusting the pressure. Since the interval space shaped like an annular gap between the gradient coil system 4 and the basic field magnet 2 is sealed gas-tight, an escape of air oscillations from the interval space is prevented and, thus, the noise emission of the magnetic resonance device during use is advantageously reduced. The tubes 12 not only seal the intervening space, but rather act at the same time as means of attachment for the gradient coil system 4 in the hollow, whereby the tubes 12, due to their elastic properties, advantageously enable an effective dampening of the transmission of mechanical oscillations originating from the gradient coil system 4 to the basic field magnet 2. This dampening of the structure-borne sound transmission can, with regard to transmission properties, be varied via a controllable adjustment of the internal pressure and a selection of a specific pressure medium so that, for example, mechanical resonance frequencies of the oscillation-capable system are advantageously circumvented and, thus, noise spikes that would be generated given excitation of these resonance frequencies are interrupted. Such a controlled adjustment is, for example, effected by the means of the pressure control unit 18.

In addition, the magnetic resonance device, to radiate high-frequency signals in an examination subject positioned in the magnetic resonance device, as well as to acquire magnetic resonance signals from the examination subject, includes an antenna system 6, which is a hollow cylinder which is attached via tubes 14 in a hollow surface of the gradient coil system 4. The antenna system 6 is attached via tubes 14 in an inner cylindrical surface 41 of the hollow of the gradient coil system 4 similar to the gradient coil system 4 being secured in the basic field magnet 2. The preceding specifications for the tubes 12 arranged between the gradient coil system 4 and the basic field magnet 2 and their operations correspondingly apply for the tubes 14, which are arranged between the outer surface 60 of the antenna system 6 and the inner surface 41 of the gradient coil system 4.

Although various minor modifications may be suggested by those versed in the art, it should be understood that I wish to embody within the scope of the patent granted hereon all such modifications as reasonably and properly come within the scope of my contribution to the art.

I claim:

1. A magnetic resonance device comprising a hollow having an inner boundary surface, a gradient coil system having an outer boundary surface, said gradient coil system being arranged in the hollow with an interval space between the inner boundary surface of the hollow and an outer boundary surface of the gradient coil system; and at least one flexible hollow body being arranged between the inner boundary surface and the outer boundary surface and being connected to means for adjusting the internal pressure so that the interval space can be sealed.

2. A magnetic resonance device according to claim 1, wherein the hollow body is constructed so that the interval space is sealed gas-tight.

3. A magnetic resonance device according to claim 2, wherein the hollow body is constructed to attach the gradient coil system in the hollow.

4. A magnetic resonance device according to claim 3, wherein a cavity of the hollow body is connected with a pressure control unit to control the inner pressure of the hollow body.

5. A magnetic resonance device according to claim 4, wherein the hollow body is constructed of an elastic material.

6. A magnetic resonance device according to claim 5, wherein the elastic material is rubber.

7. A magnetic resonance device according to claim 1, wherein means for adjusting the internal pressure in the hollow body includes introducing a pressure medium into the hollow body.

8. A magnetic resonance device according to claim 7, wherein the pressure medium is air.

9. A magnetic resonance device according to claim 1, wherein the hollow body is constructed as an annular tube.

10. A magnetic resonance device according to claim 1, which includes an antenna system being arranged in an inner hollow surface of the gradient coil system with an outer surface of the antenna system being spaced from the inner surface of the gradient coil system and at least one additional hollow body being arranged between the outer surface of the antenna system and the inner surface of the gradient coil system.

11. A magnetic resonance device according to claim 10, wherein at least one of the hollows is constructed as a cylindrical hollow.

12. A magnetic resonance device according to claim 11, wherein at least one of the hollows has two opposite openings.

13. A magnetic resonance device according to claim 10, wherein one of the gradient coil system and the antenna system is constructed as a hollow cylindrical body member.

14. A magnetic resonance device according to claim 1, wherein the hollow body attaches the gradient coil system in the inner surface of the hollow.

15. A magnetic resonance device according to claim 1, wherein the cavity of the hollow body is connected with a pressure control unit to control the internal pressure.

16. A magnetic resonance device according to claim 1, wherein the hollow body is constructed from an elastic material.

17. A magnetic resonance device according to claim 16, wherein the elastic material is rubber.
